(19) United States
(12) Patent Application Publication
(10) Pub. No.: US 2010/0251349 A1
(43) Pub. Date: Sep. 30, 2010

(54) Mobile ESN for XM Radio Receivers

(75) Inventor: Robert C. Bannick, Waterford, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 12/414,853

(22) Filed: Mar. 31, 2009

(51) Int. Cl. H04L 9/32; H04H 20/74

(52) U.S. Cl. 726/7; 455/3.02

(57) ABSTRACT

A system and method for enabling authorized satellite radio access allows users with multiple vehicles to move their radio subscription from one authorized vehicle to another without having to hold two separate subscriptions. In an embodiment of the invention, an XM receiver includes a portable media input, and the XM receiver is programmed to read for the presence of a USB device, SD card, or other peripheral media device containing an authorization code linked to the electronic serial numbers (ESNs) of the XM receivers in the user's vehicles. In addition to having an authorized and subscribed ESN, the XM receiver in each vehicle requires the presence of the portable media device for the receiver to play XM content. The portable media device can also be used to transfer the subscription to a home stereo system, computer, or aftermarket device to allow.

### BACKGROUND OF THE INVENTION

Among the entertainment options available to consumers in modern times, audio entertainment options are the most popular for users who must perform tasks such as working or driving while they are entertained. However, traditional audio entertainment options leave much to be desired in terms of selection and availability. To meet this problem, satellite radio options have become increasingly popular, and have now gone from being novel to being fairly standard. Indeed, many vehicles now arrive equipped and ready to accept a satellite radio subscription.

However, the popularity of satellite radio service only serves to make its shortcomings that much more acute. For example, the inventor has observed that customers who decline to subscribe to XM radio service sometimes feel that they cannot justify the expense of the subscription because they are not in their vehicle long enough each day, and/or they own and operate multiple vehicles. In such cases, the consumer may not wish to purchase multiple subscriptions, i.e., a subscription for each vehicle or location. Currently, the only alternative is to pay for multiple subscriptions. Although in some such cases the service provider may offer multiple car discounts, the customer still perceives that they are paying for multiple subscriptions, and in fact, they are.

In light of this, it has long been a challenge, unsolved until the invention described herein, to facilitate fair pricing for multi-location use of a satellite radio subscription by distinguishing such use from concurrent use by multiple parties.

### BRIEF SUMMARY OF THE INVENTION

The invention allows those with multiple vehicles to move their XM Radio subscription from one authorized vehicle to another without having to hold two separate subscriptions. In an embodiment of the invention, an XM receiver includes a portable media input, and the XM receiver is programmed to read for the presence of a USB device, SD card, or other peripheral media device containing an authorization code linked to the electronic serial numbers (ESNs) of the XM receivers in the user's vehicles. In addition to having an authorized and subscribed ESN, the XM receiver in each vehicle requires the presence of the portable media device for the receiver to play XM content. In this way, the portable media device can be moved from one authorized vehicle to another authorized vehicle allowing an XM subscription to follow the driver, and not to be limited to a single vehicle.

This effectively allows a customer to have a single subscription to XM and to take to dynamically transfer the subscription between vehicles that they own. All such vehicles would be on an XM Companion Subscription Plan associated with the customer, and any one of them would be enabled as long as the portable media device was present.

In another embodiment of the invention, the portable media device can also be transferred to a home stereo system, computer with internet connection, or aftermarket device to allow even greater mobility and flexibility.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile vehicle communication system;

FIG. 2 is a more detailed schematic diagram of a telematics system within which the invention may be implemented;

FIG. 3 is a flow chart illustrating a process of activating satellite radio service according to an embodiment of the invention; and

FIG. 4 is a data diagram showing the data structures used in the activation process according to an embodiment of the invention.

### DETAILED DESCRIPTION OF THE INVENTION

Before explaining the details of the invention and the environment wherein the invention may be used, a brief overview is given to guide the reader. In overview, not intended to limit the claims in any way, the invention provides a system and method to allow XM subscribers with multiple vehicles to move their XM radio subscription from one authorized vehicle to another without having to hold multiple subscriptions. In an embodiment of the invention, an XM receiver includes a portable media input, which may be a hardware input such as a USB, SD, or other peripheral media input, or which may be a non-hardware input such as an IR or RF input. In this embodiment of the invention, the XM receiver continuously or periodically reads for the presence of a peripheral media device containing an authorization code linked to the electronic serial numbers (ESNs) of the XM receivers associated with the subscriber.

In this way, the combination of an authorized and subscribed ESN and the portable authorization media device allows the receiver to play XM content. This allows XM radio service under a given subscription to be used in any one of a plurality of authorized vehicles and devices associated with the subscriber, without increasing the risk of improper usage, i.e., the use of a single subscription simultaneously by multiple users, only one of whom is an authorized subscriber. Other systems within which the portable authorization media may be used include home stereo systems, home computer systems, and other aftermarket devices.

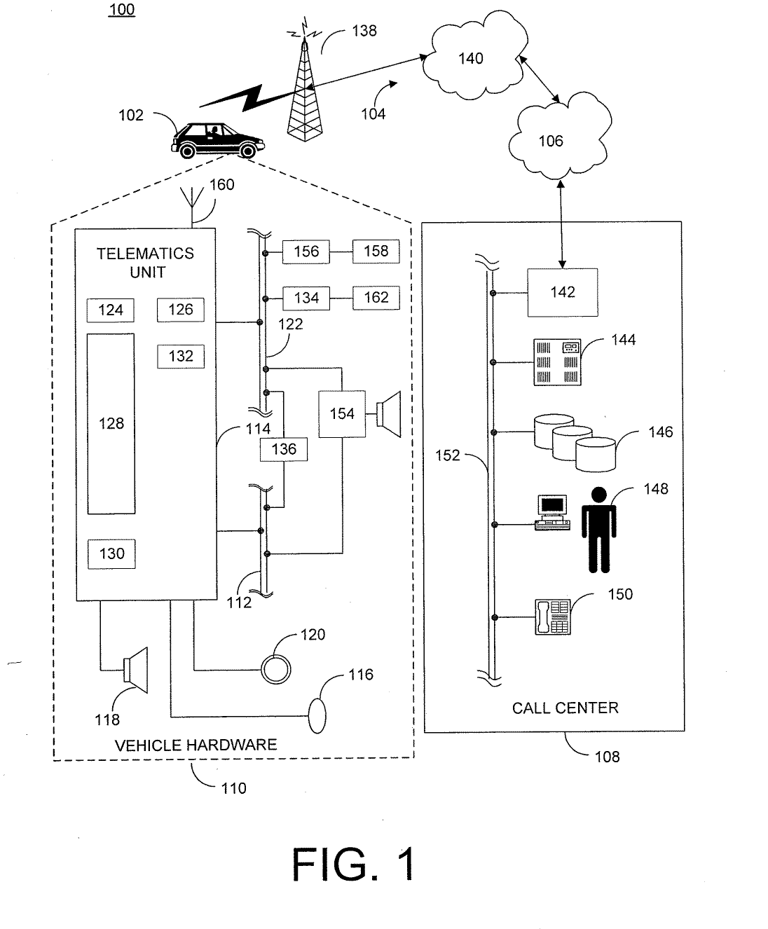

An exemplary environment in which the invention may operate is described hereinafter. It will be appreciated that the described environment is an example, and does not imply any limitation regarding the use of other environments to practice the invention. With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128. The cellular chipset/component 124 and the wireless modem 126 may be called the network access device (NAD) 180 of the telematics unit.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing.

The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

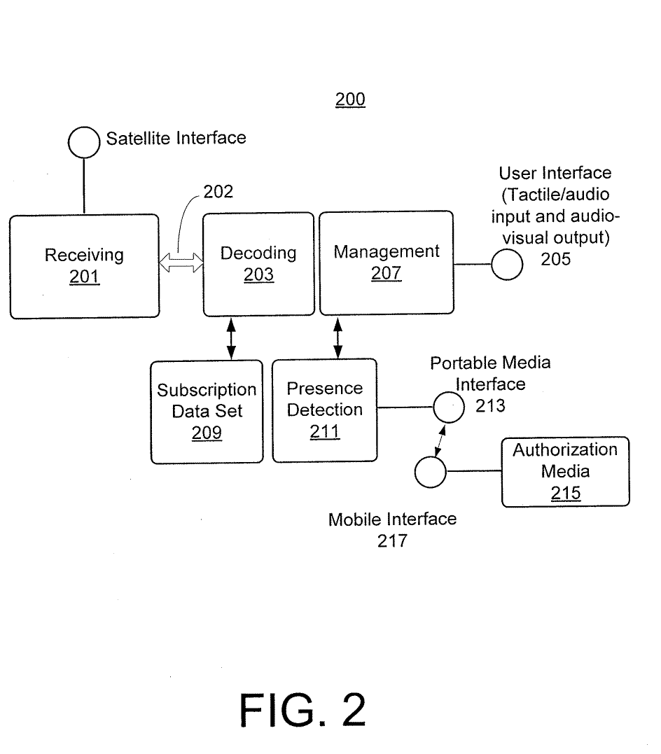

FIG. 2 is a more detailed schematic diagram of a satellite receiver system within which the invention may be implemented. As will be appreciated by those of skill in the art, the illustrated architecture 200 may be, and often will be, a component of a larger system, such as a telematics unit or otherwise, and/or may be segmented as shown or may include more or fewer elements combined or separated differently than is shown.

The illustrated architecture 200 includes a Receiving module 201 responsible for receiving satellite transmission data and forming a data stream there from. The data stream formed by the Receiving module 201 may represent all or only a portion of the information in the satellite transmission. In the illustrated embodiment, the data stream 202 produced by the Receiving module 201 is an encoded digital stream.

The encoded digital stream 202 produced by the receiving module 201 is passed to the decoding module 203, which is responsible for decoding all or a portion of the stream 202. In particular, to avoid unnecessary processing, the decoding module may decode metadata regarding the content of the stream and may decode portions of the stream, if any, that are to be provided to the user via the user interface 205. It will be appreciated that the output of the decoding module 203 may be controlled by a management module 207, and may be further processed prior to transmission to the user interface 205.

The decoding module 203, under the control of the management module 207, determines what, if any, portions of the satellite transmission are to be transmitted to the user interface 205 based on execution of an authorization decision within the decoding module 203 or the management module 207. The authorization decision executed by the decoding module 203 or the management module 207 is based on the content of a subscription data set 209 combined with input from a presence detection module 211. The subscription data set describes the user's subscriptions, i.e., what materials the user is to have access to and any qualifications regarding that access.

The presence detection module 211 is linked to a portable media interface 213. The portable media interface 213 is adapted to receive one or more types of user-portable media 215, such as thumb drives, flash drives, USB devices, SD cards, etc. In an embodiment of the invention, the portable media interface 213 is alternatively or additionally adapted to receive data from non-contact media such as RF and/or IR media.

The user-portable media 215 has associated therewith a mobile interface 217, for providing contact or non-contact communication as discussed above with the portable media interface 213. In addition, the data provided by the user-portable media 215 is preferably provided in encrypted form so that it is not susceptible to sniffing and/or eavesdropping, which would otherwise make the creation of duplicate media possible. The decryption of the authorization information from the user-portable media 215 in the illustrated embodiment resides within the presence detection module 211. However, it will be appreciated that the management module 207 may alternatively or additionally perform a decryption function with respect to this material.

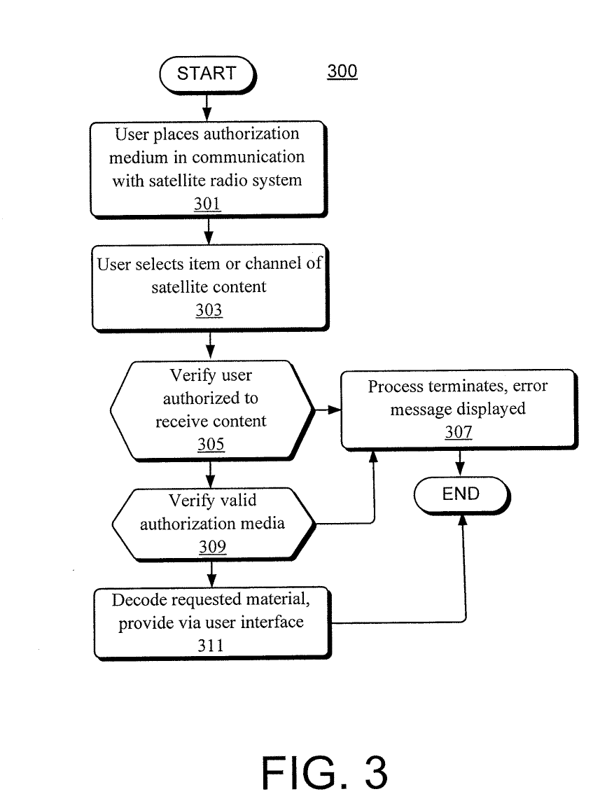

FIG. 3 is a flow chart illustrating a process 300 of activating satellite radio service according to an embodiment of the invention, with reference to the foregoing architecture 200 by way of example. The illustrated process 300 may be executed by one or more entities, in one or more locations.

At stage 301 of the process 300, the user places an authorization medium 215 in communication with the satellite radio system 200 by way of the mobile interface 217 in conjunction with the portable media interface 213 of the satellite radio system 200. This may entail sliding an SD card or USB device into a receptacle on the system 200, or placing an RF card or IR card near the system 200.

At stage 303 of the process 300, the user selects an item or channel of satellite content to access. The selection at stage 303 may be made via the user interface 205, and may be made via tactile commands, such as the pushing of buttons or other interface elements, or may be made via spoken commands via speech recognition software resident within the system 200.

In an embodiment, the user selection made in stage 303 controls the operation of the decoding module 203 in conjunction with the subscription data set and the presence detection module. In particular, at stage 305, the decoding modules verifies via the subscription data set 209 that the user is authorized to receive the content requested. If the user is not authorized to receive the requested content, then the process terminates at stage 307. An error may also be displayed to the user via the user interface 205 in this situation.

If at stage 305 it is determined that the user is authorized to receive the requested information, then the process 300 flows to stage 309, whereupon the decoding module verifies via the presence detection module 211 whether the authorization media 215 is present. In the event that the authorization media 215 is determined not to be present at stage 309, the process flows to stage 307 and terminates. Again, an error message may be displayed to the user via user interface 205, but such a message is not required.

If instead the authorization media 215 is confirmed to be present at stage 309, the process flows to stage 311. At stage 311, the decoding module decodes the requested material and provides it to the user via the user interface 205.

It should be noted that the presence detection activities of stage 309 are preferably adapted to detect the presence of an authorization medium 215 that matches the subscriber as reflected in the subscription data set 209. Thus, if another authorization medium that does not match the subscriber is presented, the presence detection module will produce a “not present” result.

Moreover, there may be multiple effective authorization media 215 in an embodiment of the invention. For example, a family multi-vehicle subscription may provide an authorization media 215 for each family member. Moreover, the authorization media 215 are personalized in an embodiment of the invention, such that they provide not only authorization data, but also user data such as preset preferences, play volume, etc.

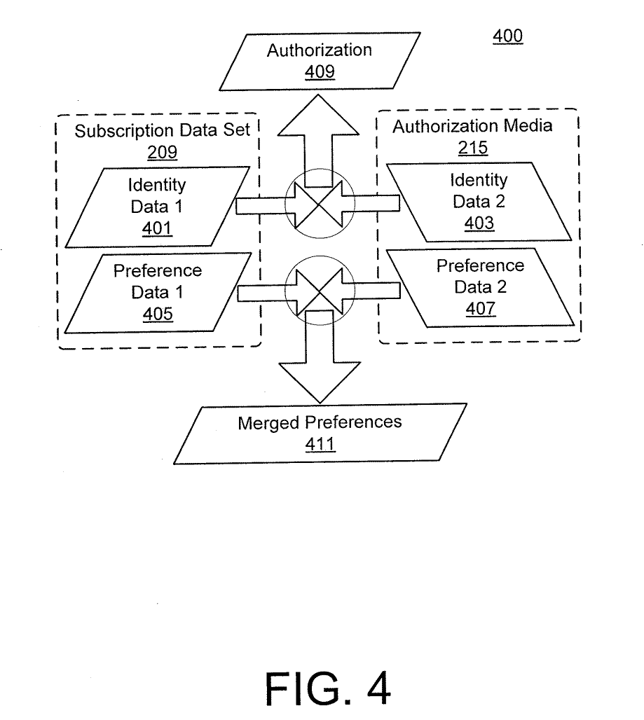

FIG. 4 is a data diagram 400 showing the data structures used in the authorization process according to an embodiment of the invention. In particular, as can be seen, the subscription data set 209 comprises Identity Data 1 (401) and Preference Data 1 (405). The Identity Data 1 (401) represents the identity of the user associated with the satellite radio system, and the Preference Data 1 (405) identifies certain preferences of that user, e.g., preferences for certain types of presentation format or content.

Moreover, the authorization media 215 contains data sets including Identity Data 2 (403) and Preference Data 2 (407). The Identity Data 2 (403) represents the identity of the user associated with the satellite radio system, and the Preference Data 2 (407) identifies certain preferences of the user to whom the authorization media 215 was issued.

The Identity Data 1 (401) and Identity Data 2 (403) are processed to yield an authorization decision 409. Similarly, the Preference Data 1 (405) and Preference Data 2 (407) are merged to yield a combined set of user preferences. In the event that Preference Data 1 (405) and Preference Data 2 are inconsistent in one or more respects, the points of difference may be resolved by date order, by giving priority to the mobile media or the system 200, or any other suitable way.

It will be appreciated that the foregoing methods and implementations for satellite radio authorization are merely examples, and that these illustrate only preferred techniques for satellite radio authorization. It is contemplated that other implementations of the invention may differ in detail from foregoing examples. All references to the invention are intended to reference the particular example of the invention being discussed at that point and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of enabling authorized use of a satellite radio system comprising:
receiving a user selection of content to be conveyed to the user;
receiving authorization data from an external user-portable medium;
retrieving an internal subscription data set representing an authorized user of the satellite radio system with respect to the selection of content;
comparing the received authorization data with the internal subscription data set; and
providing the content corresponding to the selection of content to the user if the received authorization data and the internal subscription data set match with respect to at least one preselected criterion and otherwise disallowing access of the user to the content corresponding to the selection of content.

2. The method according to claim 1, wherein receiving a user selection of content to be conveyed to the user comprises receiving a user selection via a user interface physically associated with the satellite radio system.

3. The method according to claim 1, wherein the external user-portable medium is a contact medium.

4. The method according to claim 3, wherein the external user-portable medium is one of a USB device and an SD card.

5. The method according to claim 1, wherein the external user-portable medium is a non-contact medium.

6. The method according to claim 5, wherein the external user-portable medium is one of an IR device and an RF device.

7. The method according to claim 1, wherein the received authorization data includes a first user preference data set and the internal subscription data set includes a second user preference data set.

8. The method according to claim 7, further comprising producing a merged user preference set based at least partially ion each of the first user preference data set and the second user preference data set.

9. A computer-readable medium having thereon computer-executable instructions for enabling authorized use of a satellite radio system, the computer-executable instructions including:
instructions for receiving a user selection of content to be conveyed to the user;
instructions for receiving authorization data from an external user-portable medium;
instructions for retrieving an internal subscription data set representing an authorized user of the satellite radio system with respect to the selection of content;
instructions for comparing the received authorization data with the internal subscription data set; and
instructions for providing the content corresponding to the selection of content to the user if the received authorization data and the internal subscription data set match with respect to at least one preselected criterion and otherwise disallowing access of the user to the content corresponding to the selection of content.

10. The computer-readable medium according to claim 9, wherein the instructions for receiving a user selection of content to be conveyed to the user comprise instructions for receiving a user selection via a user interface physically associated with the satellite radio system.

11. The computer-readable medium according to claim 9, wherein the external user-portable medium is a contact medium.

12. The computer-readable medium according to claim 11, wherein the external user-portable medium is one of a USB device and an SD card.

13. The computer-readable medium according to claim 9, wherein the external user-portable medium is a non-contact medium.

14. The computer-readable medium according to claim 13, wherein the external user-portable medium is one of an IR device and an RF device.

15. The computer-readable medium according to claim 9, wherein the received authorization data includes a first user preference data set and the internal subscription data set includes a second user preference data set.

16. The computer-readable medium according to claim 15, further comprising instructions for producing a merged user preference set based at least partially ion each of the first user preference data set and the second user preference data set.

17. A system for enabling authorized access to satellite radio content, the system comprising:
a satellite radio system including:
a decoding module for decoding encoded satellite radio content;
a computer-readable memory containing a subscription data set; and
a user-portable authorization media containing an authorization data set, wherein the decoding module is adapted to authorize access to the satellite radio content if the subscription data set and the authorization data set identify the same user or permissible related users, and to deny access to the satellite radio content if the subscription data set and the authorization data set do not identify the same user or permissible related users.

18. The system according to claim 17, wherein each of the subscription data set and the authorization data set includes a user preference data set.

19. The system according to claim 17, wherein the satellite radio system further comprises a user interface for receiving a user selection of satellite radio content and a portable media interface for interfacing the user-portable authorization media to the satellite radio system.

20. The system according to claim 17, wherein the user-portable authorization media is one of an SD card, a USB device, an RF card and an IR card.
